(19) United States
(12) Patent Application Publication
(10) Pub. No.: US 2005/0155161 A1
(43) Pub. Date: Jul. 21, 2005

(54) Method of producing dying pigment for yarns

(75) Inventor: Sen-Mei Cheng, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Taiwan Paiho Limited

(21) Appl. No.: 10/757,599

(22) Filed: Jan. 15, 2004

(51) Int. Cl. C09C 1/44

(52) U.S. Cl. 8/494

(57) ABSTRACT

A method of producing dying pigment for yarns includes the following steps. First, old bamboos grown for over 4 years are carbonized via burning at a high temperature into bamboo carbon which is then ground into bamboo carbon powder wherein each grain of the bamboo carbon powder thereof is equipped with a number of micro-pores that are strong in absorbing and dissolving capacities. Second, the bamboo carbon powder in a percentage of 2.5% is evenly mixed with 97.5% of polyester grains and processed at a high temperature of 450° C. into dying pigment base which, via the bamboo carbon powder of strong adhesive and dissolving capacities, is equipped with the functions of anti-bacteria, humid-adjustment, and deodorization to efficiently absorb and dissolve the odor of some harmful chemicals such as sulfide, nitride, methanol, benzene, or carbolic acid, etc. Meanwhile, infrared suitable to the absorption of human body for accelerating blood circulation and improving inner environment of human body is produced, and beneficial negative ions are increased in the air to balance the humidity and achieve anti-bug design, efficiently advancing the quality and functions of the dying pigment base thereof. Finally, the dying pigment base thereof is further applied and processed into yarns that are knitted into fabric of different kinds, greatly boosting its value in commercial use thereof.

### BACKGROUND OF THE INVENTION

The present invention is related to a method of producing dying pigment for yarns, including a dying pigment base made up of 2.5% of bamboo carbon powder evenly mixed with 97.5% of polyester grains and processed at a high temperature wherein the bamboo carbon powder is made of carbonized old bamboos grown for over 4 years and burned at a high temperature before ground into powder. Each grain of the bamboo carbon powder thereof is equipped with a number of micro-pores strong in absorbing and dissolving capacities; whereby, the dying pigment base is equipped with the functions of anti-bacteria, humid-adjustment, and deodorization to efficiently absorb and dissolve the odor of some harmful chemicals such as sulfide, nitride, methanol, benzene, or carbolic acid, etc. Meanwhile, infrared suitable to the absorption of human body for good blood circulation and body health is produced, and beneficial negative ions are increased in the air to balance the humidity and achieve anti-bug design, efficiently advancing the quality and functions of the dying pigment base thereof. The dying pigment base thereof can be further applied into yarns and knitted into fabric of different kinds, greatly boosting its value in commercial use thereof.

A conventional dying pigment for yarns is made up of polyester and color powder mixed in certain percentage and processed into polyester grains that are further applied to yarns and knitted into fabric for use. However, such conventional dying pigment thereof is not equipped with strong adhesive and dissolving capacities, which makes it unable to adjust the humidity and absorb/dissolve the odor of some harmful chemicals, or defeat bugs in the environment. Besides, it can't produce beneficial infrared suitable to the absorption of human body for good blood circulation or body health, which makes it rather inefficient in terms of functions and qualities.

### SUMMARY OF THE PRESENT INVENTION

It is, therefore, the primary purpose of the present invention to provide a method of producing dying pigment for yarns, including a dying pigment base wherein, via bamboo carbon powder of strong adhesive and dissolving capacities, the dying pigment base is equipped with the functions of anti-bacteria, humid-adjustment, and deodorization to efficiently absorb and dissolve the odor of some harmful chemicals such as sulfide, nitride, methanol, benzene, or carbolic acid, etc. Meanwhile, infrared suitable to the absorption of human body for good blood circulation and body health is produced, and beneficial negative ions are increased in the air to balance the humidity and achieve anti-bug design, efficiently advancing the quality and functions of the dying pigment base thereof. The dying pigment base thereof can be further processed into yarns and knitted into fabric of different kinds, greatly boosting its value in commercial use thereof.

### BRIEF DESCRIPTION OF THE DRAWINGS

FIG. 1 is a perspective flow diagram of the process of the present invention.

FIG. 2 is a flowchart of the process of the present invention.

FIG. 3 is a micrographic enlarged view of one grain of bamboo carbon powder of the present invention.

### DETAILED DESCRIPTION OF THE PREFERRED EMBODIMENTS

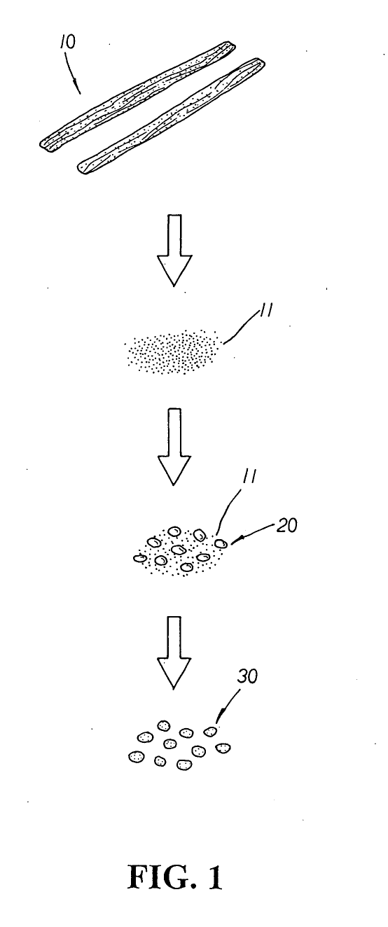

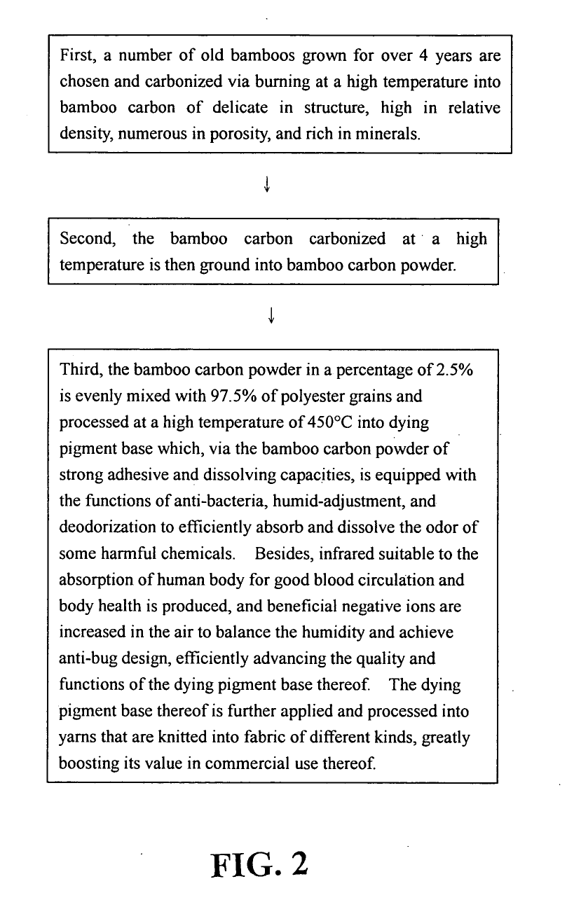

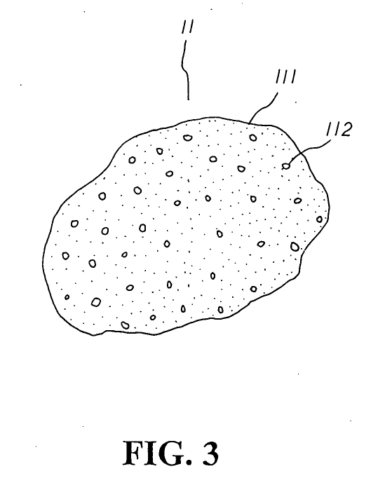

Please refer to FIGS. 1 to 3 inclusive. The present invention is related to a method of producing dying pigment for yarns, including the steps as follows;
A. A number of old bamboos grown for over 4 years are chosen and carbonized via burning at a high temperature into bamboo carbon 10 which is delicate in structure, high in relative density, numerous in porosity, and rich in minerals.
B. The bamboo carbon 10 carbonized at a high temperature is then ground into bamboo carbon powder 11 wherein each grain of the bamboo carbon powder 111 is equipped with a number of micro-pores 112 as shown in FIG. 3 which are strong in absorbing and dissolving capacities.
C. The bamboo carbon powder 11 in a percentage of 2.5% is then evenly mixed with 97.5% of polyester grains 20 and processed at a high temperature of 450° C. into dying pigment base 30 which, via the bamboo carbon powder 11 of strong adhesive and dissolving capacities, is equipped with the functions of anti-bacteria, humid-adjustment, and deodorization to efficiently absorb and dissolve the odor of some harmful chemicals such as sulfide, nitride, methanol, benzene, or carbolic acid, etc. Meanwhile, infrared suitable to the absorption of human body for accelerating blood circulation and improving inner environment of human body is produced, and beneficial negative ions are increased in the air to balance the humidity and achieve anti-bug design, efficiently advancing the quality and functions of the dying pigment base 30 thereof. The dying pigment base 30 thereof is further applied and processed into yarns that are knitted into fabric of different kinds, greatly boosting its value in commercial use thereof.

1. A method of producing dying pigment for yarns, including the steps as follows;
a number of old bamboos grown for over 4 years being chosen and carbonized via burning at a high temperature into bamboo carbon of delicate in structure, high in relative density, numerous in porosity, and rich in minerals;
the bamboo carbon carbonized at a high temperature being ground into bamboo carbon powder wherein each grain of the bamboo carbon powder thereof being equipped with a number of micro-pores which are strong in absorbing and dissolving capacities;
the bamboo carbon powder in a percentage of 2.5% being evenly mixed with 97.5% of polyester grains and processed at a high temperature of 450° C. into dying pigment base which, via the bamboo carbon powder of strong adhesive and dissolving capacities, is equipped with the functions of anti-bacteria, humid-adjustment, and deodorization to efficiently absorb and dissolve the odor of some harmful chemicals such as sulfide, nitride, methanol, benzene, or carbolic acid, etc; meanwhile, infrared suitable to the absorption of human body for accelerating blood circulation and improving inner environment of human body is produced, and beneficial negative ions are increased in the air to balance the humidity and achieve anti-bug design, efficiently advancing the quality and functions of the dying pigment base thereof; besides, the dying pigment base thereof is further applied and processed into yarns which are knitted into fabric of different kinds, greatly boosting its value in commercial use thereof.
